(19) United States
(12) Patent Application Publication
(10) Pub. No.: US 2009/0321522 A1
(43) Pub. Date: Dec. 31, 2009

(54) UTILIZING DATA FROM PURCHASES MADE WITH MOBILE COMMUNICATIONS DEVICE FOR FINANCIAL RECORDKEEPING

(76) Inventors: Jonathan Charles Lohr, Cary, NC (US); Toby Bowen, Durham, NC (US); Don Schoppe, Apex, NC (US); Yojak Vasa, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/164,263

(22) Filed: Jun. 30, 2008

(51) Int. Cl. G06K 7/10

(52) U.S. Cl. 235/462.13

(57) ABSTRACT

A system and method of using a portable network device to record recording data associated to a transaction made. Transaction data obtained from a transaction, which may be executed with a portable network device, is utilized to categorize the transaction. In one aspect, the transaction may be categorized based on one or more parameters associated with the transaction. In one aspect, a transaction may be conducted with the portable network device and categorized based on a location of the portable network device at the time the transaction was conducted.

### TECHNICAL FIELD OF THE INVENTION

The present invention relates to a system for using a portable network device for recording data related to transactions and, in particular, systems and methods for using a portable network device for recording data related to transactions made with the portable network device.

### DESCRIPTION OF THE RELATED ART

The use of portable network devices, such as mobile phones, personal digital assistants (PDA's), and the like, to carry out various types of transactions is becoming more prevalent. For example, portable network devices are sometimes used in place of cash, checks, debit cards, or credit cards to pay for goods or services that are being purchased. These traditional modes of payment, however, may be susceptible to fraud. Conducting transactions using portable network devices such as cell phones may reduce the likelihood of fraud and provide more secure transactions.

For persons making purchases or expenditures that are related to a business purpose it is often necessary to have proof or confirmation of such expenditures in order to get reimbursed by their employer, for accounting purposes, for tax purposes or for various other recordkeeping requirements. This typically requires collecting various receipts, which may need to be physically separated into business receipts and personal receipts. A transaction made with a portable network device may be saved in a program on the phone that requires user input to identify the type of transaction.

### SUMMARY

To improve a user's capacity to record and store meaningful information from a transaction conducted with a portable network device, there is a need for enhanced functionality to record and categorize a transaction conducted with a portable network device.

According to one aspect of the invention, a method of operating a portable network device for keeping records of transactions executed with the network device, the method comprising: obtaining transaction data associated with a transaction; recording the transaction data associated with the transaction, the transaction data being recorded by a recordkeeping application residing in the portable network device; determining at least one parameter associated with the transaction data; and categorizing the transaction recorded by the recordkeeping application based on the determined at least one parameter associated with the transaction.

In one embodiment, the method comprises executing the transaction with the network device.

In one embodiment of the method, the transaction is a financial transaction, and the at least one parameter is chosen from the location associated with the transaction, an identifier associated with a payee, a time of the transaction, a class of item purchased in the transaction, an account used to execute the transaction, or a combination of two or more thereof.

In one embodiment of the method, the at least one parameter includes a location associated with the transaction, and the location associated with the transaction is determined by the position of the portable network device at the time the transaction is executed.

In one embodiment of the method, the position of the portable network device is determined by GPS.

In one embodiment of the method, the location of the transaction is determined from a location tag included in the transaction data.

In one embodiment of the method, the at least one parameter includes an identifier associated with a payee, and the identifier is chosen from a payee classification, a payee name, or both a payee classification and a payee name.

In one embodiment of the method, the transaction is a non-financial transaction.

In one embodiment of the method, obtaining transaction data comprises obtaining a receipt associated with the transaction that includes transaction data, and operating the portable network device to capture the transaction data from the receipt.

In one embodiment of the method, the transaction data is encoded in a bar code printed on the receipt, and operating the portable network device to capture the transaction data comprises scanning the bar code with a scanning device located on the portable network device.

In one embodiment of the method, the portable network device comprises a camera function and operating the portable network device to capture the transaction data comprises capturing an image of the receipt and converting the image to a textual representation of the information displayed on the receipt.

In one embodiment of the method, the method includes automatically categorizing the transaction as a first category upon execution of the transaction and determination of the parameter associated with the transaction data.

In one embodiment of the method, the method includes requesting user selection of a category under which the transaction should be categorized.

According to another aspect of the invention, a method for operating a portable network device for keeping records of transactions executed with the network device includes executing a transaction with the portable network device; recording transaction data associated with the transaction as part of a transaction record, the recorded transaction data residing in the portable network device; determining the location of the portable network device at the time the transaction was executed and associating that location with the transaction record; comparing the determined location of the portable network device at the time the transaction was executed to a reference location; and categorizing the transaction record based on the relationship of the determined location relative to the reference location.

In one embodiment of the method, determining the location of the portable network device at the time the transaction was executed is performed using GPS.

In one embodiment of the method, a transaction record having an associated location falling outside a boundary defining the reference location is categorized as a first category, and a transaction record having an associated location within a boundary defining the reference location is categorized as a second category.

In one embodiment of the method, the first category is identified as a business category.

In one embodiment of the method, the categorized transaction record is stored on the recordkeeping application.

In one embodiment of the method, the categorized transaction record is transferred from the portable network device to a host computer external to the portable network device.

According to another aspect of the invention, a portable network device for conducting a transaction comprises a network communication system; a user interface; a transaction application; and a recordkeeping application for recording and categorizing transactions conducted with the portable network device, wherein upon execution of a transaction by the transaction application, the recordkeeping application records transaction data associated with the transaction and categorizes the transaction based on a predetermined parameter associated with the transaction data.

These and other features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described or illustrated with respect to one embodiment may be used in the same way or in a similar way in one or more other embodiments and/or in combination with or instead of the features of the other embodiments.

It should be emphasized that the term “comprises/comprising” when used in the specification is taken to specify the presence of stated features, integers, steps, or components, but does not preclude the presence or addition of one or more features, integers, steps, components, or groups thereof.

### BRIEF DESCRIPTION OF THE DRAWINGS

Aspects of the invention may be better understood with reference to the following drawings. The components of the drawings are not necessarily to scale, emphasis instead being placed upon clearly illustrating the principles of the present invention. Likewise, elements and features in one drawing may be combined with elements and features depicted in other drawings. Moreover, like reference numerals designate corresponding parts throughout the several views.

While the diagrams or flow charts may show a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

FIG. 1 is a diagram representing exemplary architecture for utilizing a portable network device to initiate and authorize a transaction and subsequently record aspects of that transaction in accordance with one embodiment of the present invention;

FIG. 2 is a ladder diagram representing an exemplary method of conducting a transaction with a portable network device and recording details regarding the transaction;

FIG. 3 is a block diagram representing a method of recording and categorizing a transaction made with a portable network device in accordance with one embodiment of the present invention; and

FIG. 4 is a block diagram representing a method of representing a transaction executed with transaction data representing a transaction executed with a portable communication device.

### DETAILED DESCRIPTION OF EMBODIMENTS

The term “electronic equipment” as referred to herein includes portable radio communication equipment. The term “portable radio communication equipment”, also referred to herein as a “mobile radio terminal” or “portable network device”, includes all equipment such as mobile phones, pagers, communicators, e.g., electronic organizers, personal digital assistants (PDAs), smart phones or the like.

Many of the elements discussed in this specification, whether referred to as a “system” a “module” a “circuit” or similar, may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

Table and/or database structures represented in this application are exemplary only and intended to show the mapping of relationships between various data elements. Those skilled in the art will recognize that other table and/or database structures may store similar data elements in a manner that maintains the relationships useful for the practice of the present invention without departing from the scope of the present invention.

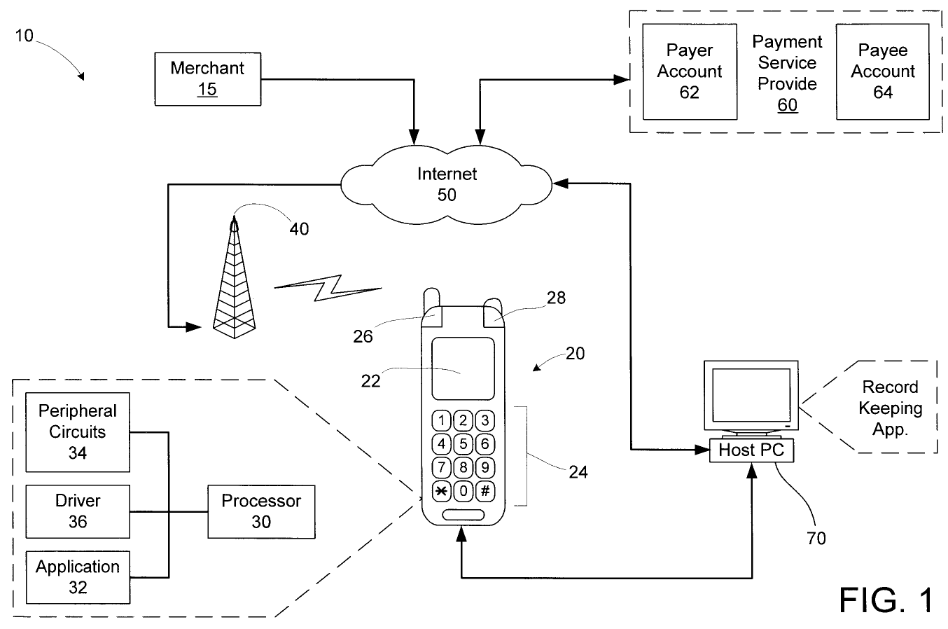

With reference to FIG. 1, exemplary architecture for a system utilizing a portable network device to conduct a transaction with a second party is shown. The system 10 enables a user of the portable network device 20 to conduct a transaction, e.g., a payment transaction with a merchant or sales/services provider. The system enables a user of the portable network device 20 to authorize a payment service provider 60 to generate a payment transaction such as from a payer account 62 to a payee account 64 (e.g., to a merchant payee 15) utilizing a payment application operating on the portable network device.

The portable network device 20 may include a processor 30 for executing applications 32 and drivers 36 for peripheral circuits 34. The peripheral circuits 34 include a network communication system 26 for internet access through a wide area network communication services provider 40 (e.g. mobile telephone service provider), a GPS system 28 for enabling the portable network device 20 to determine its position, and a user interface which may include a display 22 and a keypad 24. The drivers 36 include applicable driver code for driving operation of each of the peripheral circuits 34. The applications include a transaction application for authorizing a payment transaction in accordance with an embodiment of the present invention, and a recordkeeping application to record transaction data associated with a transaction, and store such data such that it resides on the portable network device. The transaction application and recordkeeping application may be separate applications, operative to communicate with each other, or they may be integrated within a single application. The applications 32 may also include applicable applications for other functions of the portable network device such as a mobile telephone application and typical PDA applications such as email, web browsing, contact book, and other known applications.

The system 10 may also include a host computer 70, e.g., a personal PC or a network data base, to which a transaction record may be uploaded from the portable network device 20.

Methods of conducting transactions with a portable communication device are known, and the manner in which a transaction is conducted using a portable communication device is not limited in any manner. For example, a transaction may be carried out by a wireless connection made between a merchant's transceiver and a transceiver in a portable network device. The wireless connection is not limited in any manner and may be made by, for example, Bluetooth, infrared, ultrasonic, radio frequency identification (RFID), near field communication (NFC) broadcast, or the like.

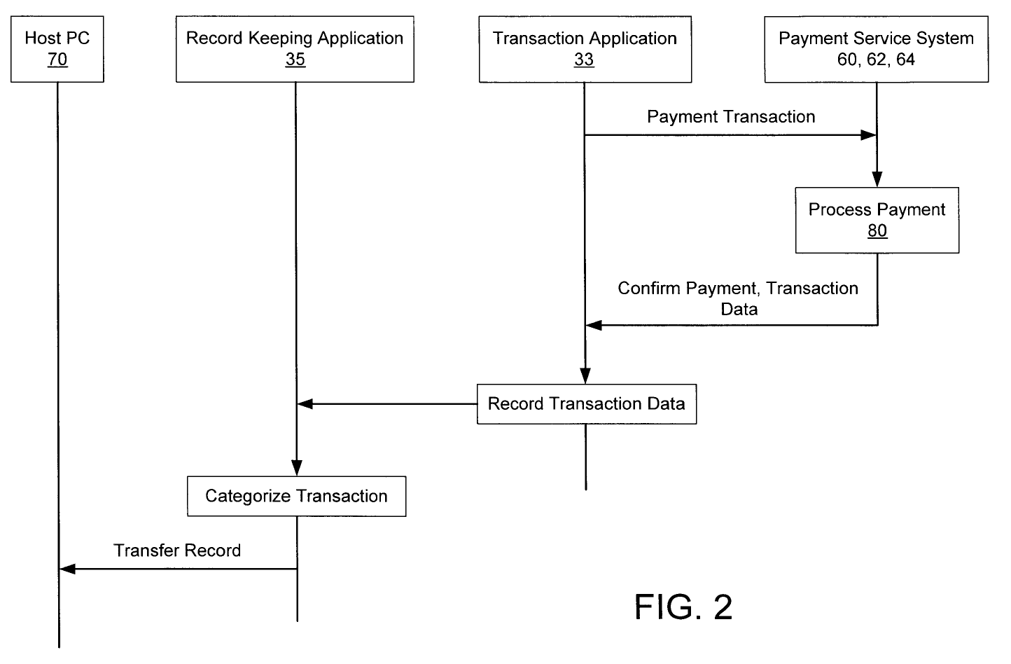

FIG. 2 is a ladder diagram representing exemplary operation of the system for a user of the portable network device 20 to make a purchase from a merchant. The transaction may be initiated in any suitable manner such as, for example, by a connection made between a merchant's transceiver and a transceiver in a portable network device. The payment application 33 generates a payment transaction to the payment service provider system 60. It will be appreciated that generation of a payment transaction may require user interaction including, for example, entering a payment amount, entry and/or authentication of a personal identification code, and the like. The transaction application may establish a connection or session (e.g., a TCP/IP connection or simple object access protocol (SOAP) session) with the transaction service provider through a combination of the Internet and the wide area network service provider (e.g., mobile telephone service provider) servicing the portable communication device. The transaction may identify the payee account to be debited (which may be stored locally on the portable communication device by the transaction application), an indication of the account to be credited (e.g., a payee account), the payment amount, and authentication such as the personal ID code of the user authorizing the payment transaction.

Step 80 represents the transaction services system processing the payment transaction. The transaction services system may generate confirmation to the payment application and the second party's (e.g., merchant's) system. Such confirmation is typically made through a connection or session compatible with an open web services session. The transaction confirmation may be in the form of an ID code provided by the transaction service provider.

During generation and processing of a transaction, transaction data associated with the transaction is produced. Transaction data generated during a payment transaction may include, for example, the transaction amount, the account from which the transaction amount is being paid, the date of the transaction, the time of the transaction, the payee's name, the location of the transaction, and the like. As illustrated in FIG. 2, the transaction data may be sent to the transaction application and recorded on the portable network device. The transaction record may be categorized by the recordkeeping application 35. The transaction record may be automatically stored by the recordkeeping application. Alternatively, the recordkeeping application may drive a user interface and prompt the user to confirm whether the record should be saved or may be discarded. The transaction application and the recordkeeping application are described separately for the purpose of describing aspects of the invention. As described above, these applications may be embodied as separate applications or a single application capable of performing the desired functions and operations of carrying out a transaction and recording transaction data associated with the transaction.

As shown in FIG. 2, the recorded transaction that contains various transaction data may then be transferred or uploaded to a host computer such as a personal computer or a network data base.

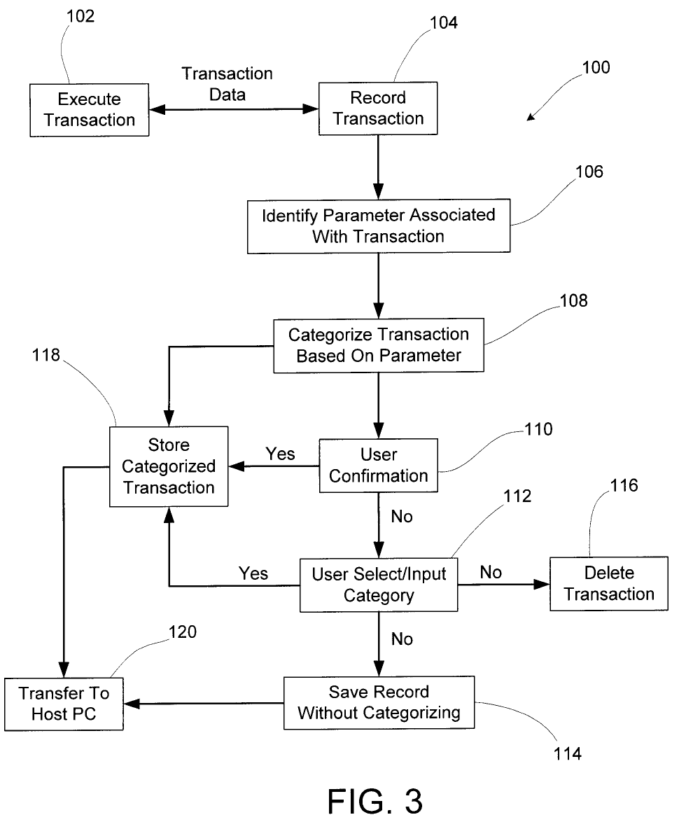

In accordance with aspects of the present invention, the method for recording financial transactions conducted with a portable network device comprises categorizing a financial transaction record. FIG. 3 illustrates a method 100 for categorizing transactions conducted with a portable network device. In block 102, a transaction is executed using a portable network device. Data associated with the transaction is recorded using the recordkeeping application on the portable network device, as shown in block 104. As shown in block 106, at least one selected parameter associated with the transaction data is then identified by the recordkeeping application. As shown in block 108, the transaction is then categorized based on the selected, identified parameter(s) associated with the transaction data. Block 118 represents saving the categorized transaction record.

As shown in FIG. 3, the categorized transaction data may be automatically saved, wherein the method proceeds from block 108 to block 118. Optionally, the application may drive a user interface to request confirmation and/or user selection of a category. As shown in block 110, the method may include requesting user confirmation of the category under which a transaction record was categorized. If the user confirms that the category is acceptable, the method may proceed to block 118 and store/save the categorized transaction records.

If the user does not confirm that the category is acceptable or correct, the recordkeeping application may drive the user interface to request that the user select a category name (such as from a menu of categories) or manually input a category name under which the transaction record is to be categorized. If the user selects or inputs a category name, the method may proceed to store/save the categorized transaction record. If the user does not select or input a category, the transaction record may be deleted (block 116) or saved without being categorized (block 114).

It will be appreciated that if the user does not confirm or accept the initial categorization based on the selected transaction parameter, the application may be programmed with a default feature such that the record is automatically categorized under a second category. For example, a recordkeeping application may categorize a transaction record as a business expense based on a selected parameter identified in the transaction data. If a user does not confirm that this categorization is correct, the recordkeeping application may then re-categorize the transaction record as a personal expense by default.

The parameter or set of parameters upon which categorization of a transaction record occurs is not particularly limited and may be selected from any parameter associated with the transaction. Examples of suitable parameters include, for example, the name of a second party to the transaction (e.g., a payee), a classification for identifying a second party in the transaction (e.g., a restaurant, hotel, airline, person, etc.), a class of item(s) purchased during a transaction a location of the transaction, a location of the device at the time of the transaction, a time of the transaction, an account used to conduct the transaction, and the like.

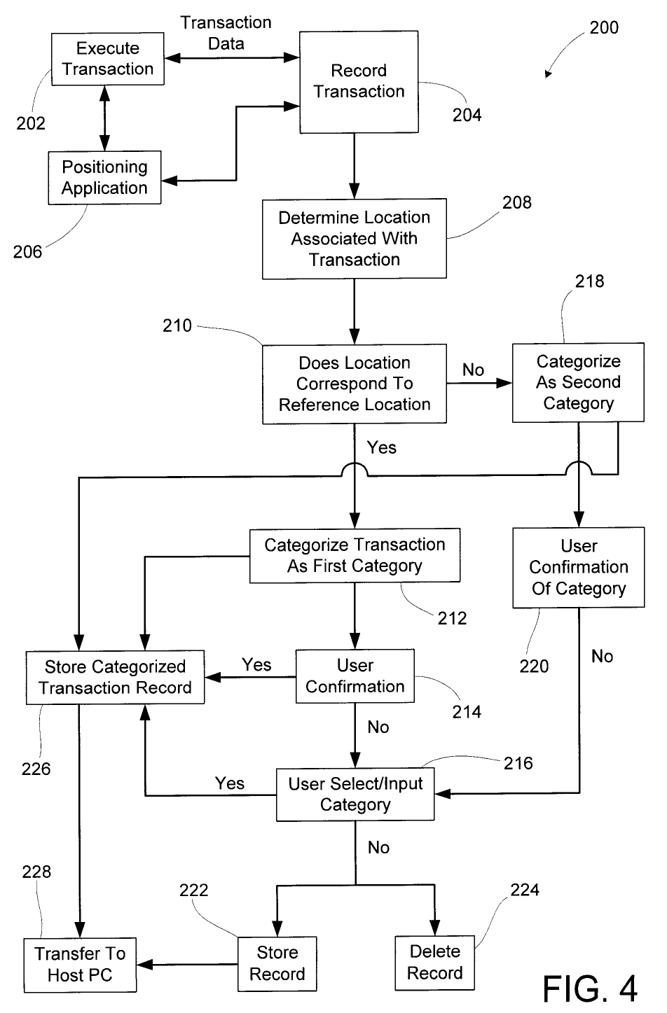

In one embodiment, the parameter upon which categorization of a transaction record occurs may include a location based parameter. In one embodiment, the location based parameter may relate to the location of the portable network device at the time the transaction is executed. FIG. 4 illustrates a block diagram of a method 200 of categorizing a transaction conducted with a portable network device based on a location of the device when the transaction is made. A transaction is executed with the portable network in block 202 device and the transaction data associated with the transaction is recorded in block 204 using the recordkeeping application. The portable network device comprises a positioning/location application or system 206 operable to determine the position of the portable network device. The positioning/location application or system may be, for example, a GPS application/system.

The positioning/location application may be operable to communicate with the transaction application and/or recordkeeping application such that the position/location of the portable network device is recorded and stored when a transaction is executed. The recordkeeping application then determines the position/location of the portable network device for the transaction, as shown in block 208. The recordkeeping application may comprise a set of data identifying a set of geographic parameters that identify a reference or “home” position/location of the portable network device. The recordkeeping application then compares the location of the device at the time the transaction is made to a reference programmed position or location of the device, as shown in block 210. If the location recorded at the time of the transaction differs from or is outside the reference location, the recorded transaction may be recorded under a first category as shown in block 212. If the location of the device at the time of the transaction is within the reference location, the transaction may be categorized under a second category as shown in block 218.

A transaction record categorized under a first category, as shown in block 212, may then be stored on the portable network device, as shown in block 226.

As shown in block 214, the method may include driving a user interface to request user confirmation of the first category and, if the first category is not confirmed, user selection or input of another category as shown in block 216. The method may also include user confirmation of the second category (block 220) and input or selection of another category if the second category is not confirmed. If no category is confirmed or selected, the uncategorized transaction record may be saved (block 222) or deleted (block 224).

The recordkeeping application may be pre-programmed to define the “home” or reference location as a selected geographic region to suit a particular purpose or intended use. For example, the home or reference location may be defined as a street, a set of streets, a city, a subset of a city, a county, a state, a province, a region (e.g., a collection of cities, counties, provinces, states, etc.), a country, and the like.

The method may be used, for example, to categorize an expense as a business expense or a personal expense. In the method described with respect to FIG. 4, for example, the recordkeeping application may be programmed to categorize transactions executed outside the home or reference location as business expenses, and transactions executed within the home or reference location may be categorized as personal expenses.

In another embodiment, the location of the transaction may be obtained by information extracted from the transaction data. For example, the transaction data may include a location tag identifying a city, state, province, zip code, area code, country, and the like. Again, this location data may be compared to a reference area and categorized depending on whether the location data associated with the transaction is within the reference location or external to the reference location.

The parameter associated with the transaction upon which the transaction is categorized may be selected from another parameter or set of parameters associated with the transaction. In one embodiment, for example, the selected parameter upon which the recorded transaction is categorized may be the name of the payee. In another embodiment, the transaction record may be categorized based on a classification system identifying a type of payee (e.g., restaurant, hotel, airline, etc.).

In another embodiment, the selected parameter for categorizing a recorded transaction may include the account number that was used to execute the transaction. It will be appreciated that a user may have multiple accounts from which to choose to execute a transaction. The account number used to execute a transaction may be included in the transaction data associated with a transaction. The recordkeeping application may be programmed to categorize a recorded transaction based upon the account used to execute the transaction. For example, a transaction conducted with a first account may be recognized as a first category, e.g., a business expense, and a transaction conducted with a second account may be recognized by the recordkeeping application as a second category, e.g., a personal expense.

As previously discussed, the transaction may be categorized by a set of parameters associated with a transaction. In one embodiment, for example, the set of parameters may include the time and location of the transaction. As a specific, non-limiting example, the recordkeeping application may be programmed such that a transaction conducted on a weekday between 7:00 A.M. and 9:00 A.M. at a selected location or a class of locations (e.g., a restaurant) would be classified as “business: breakfast expense.”

The recordkeeping application may categorize the transaction based on the presence or absence of a selected parameter. For example, the data associated with a transaction may include the items purchased as part of the transaction. The recordkeeping application may then determine whether the transaction includes a particular item or group of items or class of items; if the data includes the item or all the items in a defined group, the transaction may be categorized under a first category, and a transaction that does not include the defined item or class of items may be categorized as a second category. For example, the recordkeeping application may categorize a transaction that includes the purchase of an alcoholic beverage but does not include the purchase of food as a personal expense, but a transaction that includes the purchase of both an alcoholic beverage and food may be categorized as a business expense. Such examples are only for purposes of illustrating possible aspects of the invention. The type and number of parameters that may be used to categorize a transaction is not limited.

The transaction application and/or recordkeeping application may execute code that evaluates, identify, and/or extract a selected data parameter or set of parameters associated with the transaction data. The rules for categorizing a transaction may be pre-defined in a recordkeeping application or may be defined or selectable by a user for a particular purpose or intended use. These applications may also execute code that is operable to communicate with a location application to determine a location of the device when a transaction is executed. It will be apparent to a person having ordinary skill in the art of computer programming, and specifically in application programming for mobile telephones or other electronic devices, how to program a mobile telephone to operate and carry out logical functions associated with this function. Accordingly, details as to specific programming code have been left out for the sake of brevity.

As discussed above, after the recordkeeping application has categorized the transaction, the transaction record may be saved. The saved transaction record may later be transferred or uploaded to a program residing on a host computer or network system external to the mobile network device. For example, financial transaction records may be transferred to a personal accounting application such as Quicken or Microsoft Money or an application located on an employer's or company's network data base. Non-financial transaction records may be transferred to an appropriate program or data base suitable for an intended use of the data related to the saved transaction. The transaction record stored on the mobile phone may be formatted to be compatible with the application to which the information is to be transferred. It will be appreciated that the recordkeeping application may be programmed such that the stored, recorded transaction data may be compatible with a variety of applications.

While the process and methods have been described with respect to financial transactions, a process in accordance with the present invention is not limited to financial transactions and may be used to save and categorize non-financial transactions. In one embodiment, a non-financial transaction may be conducted with electronic tickets and/or boarding passes stored on a portable network device. The portable network device may be used to conduct a transaction with that electronic ticket or boarding pass, e.g., to gain admittance into a desired area (e.g., an arena, a theater, or a vehicle such as a plane, a train, or the like). Upon the electronic ticket information being read by or transmitted to the intended recipient, the portable network device could record the event to provide confirmation of entry (e.g., boarding a plane) and then categorize the record based on data associated with the electronic ticket (e.g., location, time, event name, etc.). In another embodiment, a portable network device may be used as an identity pass to identify when a person enters or leaves a selected area. In this instance, the “transaction” is confirming with the portable network device and a second party (e.g., by network communication, a scanner, etc.) that the user of the portable network device entered or left a designated area at a particular time. The recordkeeping application may record the hours which may then be categorized (e.g., by day, whether the time relates to overtime, etc.), and later transferred to a host computer, e.g., an employer's computer, thereby functioning as an electronic time care. The above are only illustrations of exemplary non-financial applications, and other non-financial transaction may also be amenable for use with a process in accordance with the present invention.

It will be appreciated that the process in accordance with the present invention is not limited to transactions executed with the portable network device, and the process may be used to categorize transactions conducted in a more conventional manner such as, for example, using cash, a credit or debit card, a check, and the like.

Referring back to FIG. 1, executing the transaction in block 102 may be carried out external to the portable network device such as by using a credit card, a debit card, cash, a check, or the like. In one embodiment, transaction data may be supplied to the recordkeeping application by a user manually inputting the data (e.g., amount, name of payee, time, class of payee, etc.), and the method may proceed as illustrated in blocks 104-120.

In another embodiment, the portable network device may be used to obtain and record the transaction data even through the device was not used to execute the transaction. For example, transaction data may be obtained from information printed on a receipt received during a transaction. In one embodiment, a receipt may include a bar code that encodes data associated with the transaction. A portable network device that includes a scanner or reader may be used to scan/read the bar code and extract the desired transaction data (using appropriate application, code, and logic) for use with the recordkeeping application. In another embodiment, a camera function on a portable network device may be used to capture an image of a receipt or physical record of the transaction, and a suitable application, e.g., an optical character recognition application, may be used to convert the captured image into a text file that contains transaction data. The recordkeeping application may be programmed to recognize fields in the text file and use selected fields from the text to categorize the transaction.

The transaction data stored by the recordkeeping application on the mobile network device may be transferred to an application on an external host computer by any suitable means. The stored transaction data may be transferred via a physical connection between the portable network device and external host such as by, for example, a cable connection such as a serial cable, USB, or the like. Alternatively, the stored transaction data may be transferred to the external host by a wireless connection such as Bluetooth, RF connection, or an IR connection. In still another embodiment, the transaction data may be transferred to the host compute via an “always on” network connection such as, for example, a broadband connection.

Recording and storing transaction data and categorizing it in accordance with aspects of the present invention provides an electronic receipt for a transaction conducted with a portable network device without the need for having a hard copy of a receipt. Thus, an employee need not collect numerous receipts related to business expenses. Rather, the stored, categorized electronic version of the transaction record may be uploaded to a desired computer to save for tax purposes or to be reimbursed by an employer for a particular expense.

Although the invention has been shown and described with reference to certain exemplary embodiments, it is understood that equivalents and modifications may occur to others skilled in the art upon reading and understanding the specification. The present invention is intended to include all such equivalents and modifications as they come within the scope of the following claims.

1. A method of operating a portable network device for keeping records of transactions executed with the network device, the method comprising:
obtaining transaction data associated with a transaction;
recording the transaction data associated with the transaction, the transaction data being recorded by a recordkeeping application residing in the portable network device;
determining at least one parameter associated with the transaction data; and
categorizing the transaction recorded by the recordkeeping application based on the determined at least one parameter associated with the transaction.

2. The method according to claim 1, comprising executing the transaction with the network device.

3. The method according to claim 1, wherein the transaction is a financial transaction, and the at least one parameter is chosen from the location associated with the transaction, an identifier associated with a payee, a time of the transaction, a class of item purchased in the transaction, an account used to execute the transaction, or a combination of two or more thereof.

4. The method according to claim 3, wherein the at least one parameter includes a location associated with the transaction, and the location is determined by the position of the portable network device at the time the transaction is executed.

5. The method according to claim 4, wherein the position of the portable network device is determined by GPS.

6. The method according to claim 3, wherein the location of the transaction is determined from a location tag included in the transaction data.

7. The method according to claim 6, wherein the at least one parameter includes an identifier associated with a payee, and the identifier is chosen from a payee classification, a payee name, or both a payee classification and a payee name.

8. The method according to claim 1, wherein the transaction is a non-financial transaction.

9. The method according to claim 1, wherein obtaining transaction data comprises obtaining a receipt associated with the transaction that includes transaction data, and operating the portable network device to capture the transaction data from the receipt.

10. The method according to claim 9, wherein the transaction data is encoded in a bar code printed on the receipt, and operating the portable network device to capture the transaction data comprises scanning the bar code with a scanning device located on the portable network device.

11. The method according to claim 9, wherein the portable network device comprises a camera function and operating the portable network device to capture the transaction data comprises capturing an image of the receipt and converting the image to a textual representation of the information displayed on the receipt.

12. The method according to claim 1, comprising automatically categorizing the transaction as a first category upon determination of the at least one parameter associated with the transaction data.

13. The method according to claim 1, comprising requesting user selection of a category under which the transaction should be categorized.

14. A method for operating a portable network device for keeping records of transactions executed with the network device, the method comprising:
executing a transaction with the portable network device;
recording transaction data associated with the transaction as part of a transaction record, the recorded transaction data residing in the portable network device;
determining the location of the portable network device at the time the transaction was executed and associating that location with the transaction record;
comparing the determined location of the portable network device at the time the transaction was executed to a reference location; and
categorizing the transaction record based on the relationship of the determined location relative to the reference location.

15. The method according to claim 14, wherein determining the location of the portable network device at the time the transaction was executed is performed using GPS.

16. The method according to claim 14, wherein a transaction record having an associated location falling outside a boundary defining the reference location is categorized as a first category, and a transaction record having an associated location within a boundary defining the reference location is categorized as a second category.

17. The method according to claim 16, wherein the first category is identified as a business category.

18. The method according to claim 16, comprising storing the categorized transaction record on the recordkeeping application.

19. The method according to claim 16, comprising transferring the categorized transaction record from the portable network device to a host computer external to the portable network device.

20. A portable network device for conducting a transaction, the portable network device comprising:
a network communication system;
a user interface;
a transaction application; and
a recordkeeping application for recording and categorizing transactions conducted with the portable network device, wherein upon execution of a transaction by the transaction application, the recordkeeping application records transaction data associated with the transaction and categorizes the transaction based on a predetermined parameter associated with the transaction data.
